(19) United States
(12) Patent Application Publication
(10) Pub. No.: US 2022/0074584 A1
(43) Pub. Date: Mar. 10, 2022

(54) LIGHTING DEVICE

(71) Applicant: Masataka KAMAHARA, Kochi-shi (JP)

(72) Inventor: Masataka KAMAHARA, Kochi-shi (JP)

(21) Appl. No.: 17/401,794

(22) Filed: Aug. 13, 2021

(30) Foreign Application Priority Data
Sep. 10, 2020 (JP) 2020-152299
May 17, 2021 (JP) 2021-083223

(51) Int. Cl. F21V 31/00; F21V 9/40

(52) U.S. Cl. CPC F21V 31/005; F21V 9/40

(57) ABSTRACT

A support member is made of a material(s) that excel in both of electrical conductivity and thermal conductivity. Phosphors are applied to the surface of the support member. The phosphors include layers having a very small thickness as close as possible to a minimum quantity of phosphors that can be obtained. The phosphors are disposed on a surface of the support member in a thickness small enough to an extent that the support member is slightly glimpsed in part from between the phosphors. The support member is exposed in part out of the lighting device.

### TECHNICAL FIELD

The present invention relates to a technology available for lighting devices equipped with diamond luminous elements, more particularly to a technology that may successfully reduce or eliminate the risk of such an event that the luminous elements cease to emit light in short periods of time in response to temperature rises under high voltages.

### BACKGROUND

A broad range of light sources are available for artificial lighting, for example, incandescent bulbs, fluorescent bulbs, metal halide lamps, mercury lamps, and halogen lamps. There are issues to be addressed with these lighting devices, for example, over-consumption of electricity, and hazardous materials like mercury involve the risk of environmental disruption. In fact, all of the artificial lighting devices currently used may eventually be banned from being used at some stage in the future.

Under the circumstances, an alternative to the existing artificial light sources, field emission lamps (hereinafter, abbreviated to FEL), are now growingly drawing attention.

### CITATION LIST

### Patent Document

Patent Document 1 JP No. 2008-10169 A

### SUMMARY OF THE INVENTION

### Technical Problems

The FEL is admittedly a leading candidate of high-intensity lighting devices for future generations. Yet, a problem with the FEL remains unsolved; i.e., its product life as lighting device, which only allow the FEL to last approximately one month.

To this end, the present invention is directed to addressing the issues currently known as life-shortening factors of the FEL in order to extend the FEL product life to more than one month.

### Technical Solutions

When the FEL is turned on and operating, phosphors used in this device are subject to excessively high voltages. Such high voltages may certainly heat the phosphors to higher temperature, inviting early breakage of the overheated phosphors. This breakage of phosphors may be the origin of shorter life cycles of the FEL. The present invention, with a view to the fact that such voltage-driven temperature rises are likely to invite early breakage of the phosphors, seeks to control such temperature rises by cooling the phosphors through the convection, radiation, and conduction of heat.

A lighting device according to the present invention includes:

an emitter;

phosphors that receive electrons discharged from the emitter and that emit light toward to a surface to be irradiated with light; and

a support member that supports the phosphors, the support member including a material that excels in both of electrical conductivity and thermal conductivity.

This lighting device is further characterized in that the phosphors are present on a surface of the support member in a thickness small enough to an extent that the support member is exposable in part through fine voids between the phosphors, i.e., in a thickness small enough to an extent that the support member can only be slightly glimpsed in part from between the phosphors.

Preferably, the phosphors include a layer having a very small thickness close to a minimum quantity of the phosphors that can be obtained, and the phosphors are disposed on a surface of the support member in a thickness small enough to an extent that the support member can only be slightly glimpsed in part from between the phosphors.

In the lighting device according to the present invention thus structurally characterized, heat generated in the phosphors during the emission of light may be efficiently released out of this device from the support member through the conduction and radiation of the generated heat.

According to the present invention, the certain quantity of phosphors may be specifically defined as follows; it is a quantity of phosphors close to a minimum quantity of phosphors that can achieve an amount of fluorescence, i.e., a degree of luminance, required of the phosphors.

Preferably, the material that excels in both of electrical conductivity and thermal conductivity is a metal.

In an aspect of the present invention, the emitter may be disposed between the phosphors and the surface to be irradiated with light.

According to this aspect, light generated in the phosphors may be radiated from surfaces of the phosphors without passing through the phosphor and then directed toward the surface to be irradiated with light. This may improve the efficiency of light irradiation.

In an aspect of the present invention, the lighting device may further include a transparent sealing member that covers the emitter, the support member and the phosphors and is further characterized in that at least one of ends on both sides of the support member is penetrating through the transparent sealing member and is protruding out of the lighting device, a gap between the support member and the sealing member is sealed, and inside of the transparent sealing member is hermetically closed.

In an aspect of the present invention, ends on both sides of the support member are penetrating through the transparent sealing member and are protruding out of the lighting device.

According to this aspect in which the both end sides of the support member are exposed out of the lighting device, the efficiency of heat convection may be improved. This may be a great advantage because the convection of heat is important for the generated heat to be released (radiated) out of the lighting device through the support member. The heat release using the conduction and radiation of heat may thus achieve a further improved effect.

In an aspect of the present invention, the support member is disposed along a vertical direction in the lighting device.

According to this aspect in which the support member is disposed along the vertical direction, air heated through contact with the support member becomes lighter and is drifted upward. Then, cold air from below contacts the support member, and the air thereby heated becomes lighter and drifts upward. This event repeatedly occurs, further improving the efficiency of heat convection important for the generated heat to be released (radiated) out of the lighting device through the support member. The heat release may thus achieve a further improved effect.

In an aspect of the present invention, the support member has a cylindrical shape with an opening at one of two ends on both sides thereof, the opening at one end is protruding out of the lighting device, and an inner space of the support member having a cylindrical shape is exposed out of the lighting device through the opening at one end.

According to this aspect, the inner space of the cylindrical support member is exposed out of the lighting device without interference with the sealed interior of the lighting device. This may increase the surface area of the support member exposed out of the lighting device, offering a further improved effect of heat release.

In an aspect of the present invention, the support member has a cylindrical shape with openings at two ends on both sides thereof, the openings at two ends are protruding out of the lighting device, and an inner space of the support member having a cylindrical shape is exposed out of the lighting device through the openings at two ends.

According to this aspect, the inner space of the cylindrical support member is exposed out of the lighting device without interference with the sealed interior of the lighting device. This may increase the surface area of the support member exposed out of the lighting device, offering a further improved effect of heat release. Further, with both ends of the cylindrical inner space being exposed out of the lighting device, air may be actively circulated to and from outside of the device and the cylindrical inner space exposed out of the lighting device. This circulation of air may further improve the efficiency of heat convection that occurs in and out of the lighting device, conducing to a further improved effect of heat release.

### Effects of the Invention

The lighting devices of the known art had the problem that the phosphors used in the devices often cease to emit light in short periods of time after they are heated to higher temperature degrees. According to the present invention, on the other hand, heat generated in the phosphors during the emission of light may be quickly conducted out of the lighting device through the support member. This may eliminate or reduce the risk of temperature rises of the phosphors, allowing the phosphors to have an extended product life.

In the lighting devices of the known art, light resulting from the light emission by the phosphors needs to travel through voids between the phosphors not emitting light before departing from the phosphors, which may inevitably lead to damping of the emitted light. The lighting device according to the present invention, on the other hand, may allow all of the emitted light to successfully arrive at the surface of the lighting device and may accordingly offer a higher degree of luminance than in the known art.

### BRIEF DESCRIPTION OF THE DRAWINGS

FIG. 1 is a perspective view, illustrating the schematic structure of an FEL according to a first embodiment of the present invention.

FIG. 2 is an enlarged sectional view of a principal part of the FEL according to the first embodiment.

FIG. 3 is a conceptual view used to illustrate heat radiation in the FEL.

FIG. 4 is a conceptual view used to illustrate manufacture of the FEL.

FIG. 5 is an enlarged sectional view of a principal part of an FEL according to a second embodiment of the present invention.

FIG. 6 is an enlarged sectional view of a principal part of an FEL according to a third embodiment of the present invention.

FIG. 7 is an enlarged sectional view of a principal part of an FEL according to a fourth embodiment of the present invention.

FIG. 8 is an enlarged sectional view of a principal part of an FEL according to a fifth embodiment of the present invention.

FIG. 9 is an enlarged sectional view of a principal part of an FEL of the known art.

### EMBODIMENTS OF THE INVENTION

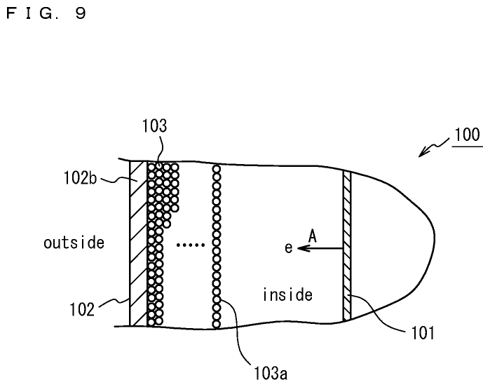

To start with, an FEL 100 of the known art is described prior to embodiments of the present invention. In the FEL 100, an inner surface 102b of an external facing glass 102, i.e., a surface to be irradiated with light, is coated with phosphors 103, as illustrated in FIG. 9. The phosphors 3 and the surface to be irradiated with light (external facing glass 2) are integral with each other.

In the FEL 100 of the known art thus structurally characterized, electrons “e” are emitted from an emitter 101 disposed at a radially central position of this device toward the phosphors 103 radially outward (direction indicated with arrow A). The electrons “e” then hit, among all of phosphor particles 103a, the phosphor particles 103a alone that are present in the innermost one of layers of the phosphors 103 and invite these phosphor particles 103 to emit light. Of the light thus emitted in all directions, light directed radially outward of the device passes through the phosphors 103 and is then radiated out of the device through the surface 102a to be irradiated with light. At the time, the light repeatedly collides with and reflects from the phosphors 103 and is accordingly damped by degrees before it finally departs from the device.

Thus, the light generated in the phosphor particles 103a emitting light passes through voids between the phosphor particles 103a not emitting light and is increasingly attenuated by the time when the light is radiated out of the FEL 100. This is a great disadvantage for the FEL 100 to function as a lighting device.

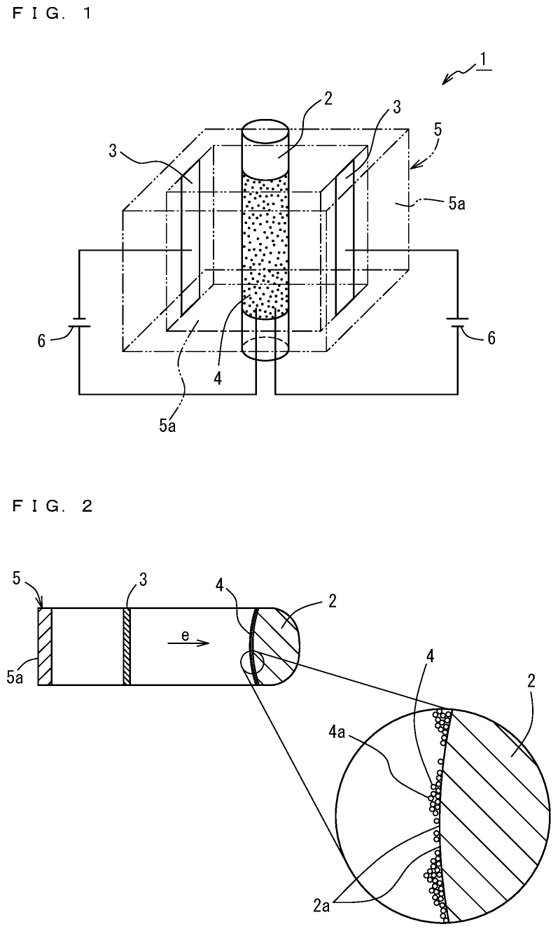

FIGS. 1 and 2 are drawings that illustrate an FEL 1 according to the present invention. FIG. 1 is a perspective view, three-dimensionally illustrating the schematic structure of the FEL 1. FIG. 2 is an enlarged sectional view of a principal part of the FEL 1. The FEL 1 includes a support member 2, a transparent sealing glass 5, and an emitter 3. The support member 2 is disposed at a radially central position of this device and includes a metal bar made of, for example, aluminum that excels in thermal conductivity. The transparent sealing glass 5 including a surface 5a to be irradiated with light is disposed at a position on the radially outer circumference this device. The emitter 3 is disposed between the support member 2 and the light-irradiating surface 5a. In the support member 2 disposed at a radially central position of this device, an axially central part of its circumferential surface is coated with phosphors 4. The phosphor-coated axially central part of the support member 2 is housed in this device, while axial ends of the support member 2 are exposed out of this device. The transparent sealing glass 5 and both ends of the support member 2 exposed out of this device are sealed and tightly closed without any gap therebetween. The structural features of the support member 2 may be optionally changed; a single metal bar may constitute the support member 2, or the phosphor-coated and exposed portions of the support member 2 may be separately formed and then integrated into one unit.

In the FEL 1, the electrons “e” discharged from the emitter 3 at a radially intermediate position of this device advance radially inward of this device and arrive at the phosphors 4. The electrons “e” that arrived at the phosphors 4 crash against the phosphor particles 4a in the outermost one of layers of the phosphors 4, inviting these phosphor particles 4a to emit light. The light emitted is radiated from the outermost one of layers of the phosphors 4 radially outward without passing through any other phosphor particles on the inner side and is then radiated out of this device through the transparent sealing glass 5 (light-irradiating surface 5a). As described earlier, the light-irradiating surface 5a constitutes the transparent sealing glass 5 that hermetically closes inside of the FEL 1. In FIG. 1, the reference sign 6 is a power source that supplies the emitter 3 and the phosphors 4 with electric power.

In the FEL 1 thus structurally characterized, light may be irradiated to the outside of this device without causing attenuation due to repeated collision-reflection inside the phosphors 4. Thus, the FEL 1 according to the present invention may be a useful lighting device improved in efficiency as compared with the lighting devices of the known art.

Hereinafter, reasons why the FEL 1 according to the present invention excels in durability are described in comparison with the known art.

A first ground is described. In the FEL 1 according to the present invention, heat generated in the phosphors 4 when and after this device is turned on may be conducted well and successfully released out of the FEL 1 through the metallic support member 2. This may conduce to effective control of temperature rises of the phosphors 4.

Next, a second reason is described. To better control temperature rises of the phosphors 4 in the FEL 1 according to the present invention, specific values are decided and set for the quantity and the thickness of layers of the phosphors 4. In the FEL 1 according to the present invention, the phosphors include layers having a very small thickness as close as possible to a minimum quantity of phosphors that can be obtained. The thickness of layers of the phosphors 4 is made as small as possible to an extent that the surface of the support member 2 can only be slightly glimpsed from between the phosphors 4, instead of being entirely covered with the phosphors 4. The quantity of phosphors 4 may be otherwise defined; the quantity of the phosphors 4 may be set to a quantity as close as possible to a minimum quantity of phosphors that can achieve an amount of fluorescence, i.e., a degree of luminance, required of the phosphors 4. By thus defining the quantity and the layer thickness of the phosphors 4, the quantity of phosphors used in this device may decrease, allowing effective control of temperature rises of the phosphors 4 during the emission of light. However, even if the amount is reduced, the brightness of FEL, that is, the values of lumens, candela, etc., does not change unless the surface of the support is exposed from the phosphors.

As described above, the brightness of the FEL is the same regardless of whether the amount of the phosphor is increased or decreased, as long as the surface of the support is not in a state where it can be glimpsed between the phosphors.

In case the surface of the support member is exposed from the phosphors, the phosphors effective for luminance may decrease correspondingly to a surface area of exposure of the support member, undermining an expected degree of luminance.

The degree of luminance of the FEL may be substantially the same regardless of whether the surface of the support member is uniformly and entirely coated with a certain quantity of phosphors or the surface of the support member is coated with an increased quantity of phosphors. The only difference between these two different coating manners is thicknesses of phosphor layers, because the layers may certainly become thicker with more phosphors.

When the surface of the support member is entirely and uniformly coated with the phosphors as described above, the phosphors are evenly present without any phosphor-unapplied part on the surface of the support member regardless of the quantity of phosphors, whether increased or decreased. The degree of luminance of the FEL remains unchanged because light is emitted in response to collision of the electrons discharged from the emitter with the entire surface of the support member. The simple fact is that the layers become thicker with more phosphors and become thinner with less phosphors.

As described later, the phosphors generally have poor thermal conductivity. Due to the fact, the phosphors, if applied to the surface in thick layers, may start to generate heat under an attack by an electron before heat generated under an earlier attack by another electron is conducted to the support member. Thus, the phosphors, under heat generated and stored in succession within the layers, may be heated to very high temperature degrees and finally reach temperatures at which temperature quenching possibly occurs. When the temperature quenching occurs, the phosphors no longer emit light.

The degree of luminance of the FEL in an initial stage after this device is turned on may not differ regardless of whether the phosphor layers are thick or thin. However, the phosphors, as their layers are thicker, may be more difficult to conduct the generated heat to the support member and accordingly less likely to emit light. The product life of the FEL may be approximately a month if the layer thickness is the same as in the known art and may be naturally longer than a month as the layer thickness is reduced.

In order to extend the product life by applying the phosphors in a small thickness to the surface of the support member, the phosphors may preferably be applied to the support member in a thickness small enough to an extent that the surface of the support member can only be slightly glimpsed from between the phosphors. This highly anticipated to significantly reduce any layers that are too thick to conduct the heat generated by collision with the electrons to the support member before temperatures are reached at which the temperature quenching possibly occurs.

In a phosphor-applied portion where the surface of the support member may be slightly glimpsed, there is unexceptionally a very thin layer(s) that allows heat generated by collision with the electrons to be conducted to the support member before the next collision occurs, though it may not necessarily be near or around where the surface of the support member is visible through the phosphor layers that are too thin.

In case the phosphors are thus applied to the support member in a manner that many of the layers are not as thin, some of the layers that are too thick may be darkened as a result of quenching, while long-life thin layers alone may be left active. Such an FEL could survive a long period of time but is most possibly too dark. Despite an attempt to apply the phosphors in a manner that more thin layers are formed, a too thick layer(s) still exists, and any relevant portion(s) may result in quenching. Yet, many of the long-life thin layers are left active. As a result, an FEL with a longer product life and a higher degree of luminance may be successfully produced.

In the FEL 1 according to the present invention, the phosphors 4 may be applied to the support member in any conventional manner suitably selected, and examples of the material that can be used to prepare the phosphors 4 may include such existing products as 22-X(r), P22-X(r), P22-X(g) and P22-X(b).

Below are indicated the characteristics and peak particles sizes (μm) in the particle size distribution of these examples of the phosphor materials.

| | | |
|---|---|---|
| P22-X(r) | Y₂0₂S; Eu | 7.5 μm |
| P22-X(r) | YVO₄; Eu | 5.0 μm |
| P22-X(g) | ZnS; Cu, Au, Al | 8.0 μm |
| P22-X(b) | ZnS; Ag | 8.0 μm |

The phosphor materials having the largest peak particle sizes are P22-X(g) and P22-X(b), particle sizes of which are 8.0 μm. Supposing that the phosphors 4 having the particle sizes of 8.0 μm are applied, as in the known art, in the thickness of 0.2 mm to the support member 2 made of a metal, layers of the applied phosphors may be roughly estimated from the following formula 1).

0.2 mm÷0.008 mm=25 1)

In the FEL 1 in which the phosphors 4 are applied to the support member 2 in the thickness of 0.2 mm, approximately 25 phosphor particles 4a are estimated to be present in layers on the surface of the support member 2.

In an effort to extend the product life of the FEL, the inventors of the present invention discussed the potentials of LED because the LED is equipped with phosphors similar to those used in the FEL and its structural features have been and are currently researched and studied. A well-known phenomenon with the white LED lamps is that the luminescence intensity of phosphors is significantly degraded after they are affected by heat from the LED chips of these lamps heated to 70 to 100° C. This phenomenon, which is referred to as the temperature quenching of phosphors, may be very likely to occur in the FEL as well. The luminescence intensity is thus degraded due to heat of approximately 70 to 100° C. generated in the phosphors. This event; degradation of luminescence intensity, made it very difficult for the conventional FELs to achieve a product life long enough for practical use.

Thus far have been presented a few models in connection with the temperature quenching of phosphors. These models suggest that the behavior of thermal vibrations of luminescent ions and variations of relevant valency, for example, are associated with the temperature quenching. These models, however, failed to clarify which one(s) of these parameters is closely associated with the temperature quenching.

The present invention, in an attempt to extend the FEL product life, tried to identify any parameters closely correlated to the temperature quenching of phosphors, addressed issues associated with the temperature quenching, and searched solutions to such issues for improvements. The achievements and improvements by the present invention are hereinafter described in detail.

The following is a hypothetical theory on what possibly invokes the degradation of phosphors in the FEL; phosphors may reach higher temperatures than the melting point as a result of temperature rises induced by the phosphors being hit by electrons at high speeds under high voltages, and resulting breakage of the heated phosphors may invite the temperature quenching. This theory, however, is found to be inappropriate, which is hereinafter described with reference to phosphors primarily consisting of an alloy Y₂O₃:Eu. The melting point of yttrium oxide Y₂O₃ a constituent of the phosphor, is 2,410° C., and the melting point of europium EU; another constituent of the phosphor, is 826° C. Thus, the melting point of the phosphors 4 primarily consisting of an alloy of these metals may no way be as low as approximately 70 to 100° C. Therefore, the following theory may also be found inappropriate; the temperature quenching occurs when the phosphors 4 are melted under heat of approximately 70 to 100°. Besides, the temperature quenching possibly occurs in the FEL when the phosphors are under heat at relatively low temperature degrees of approximately 70 to 100° C. below the melting point.

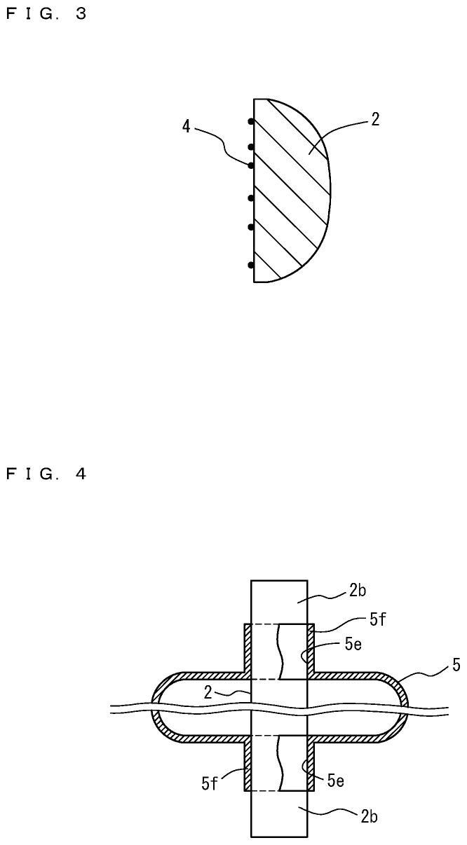

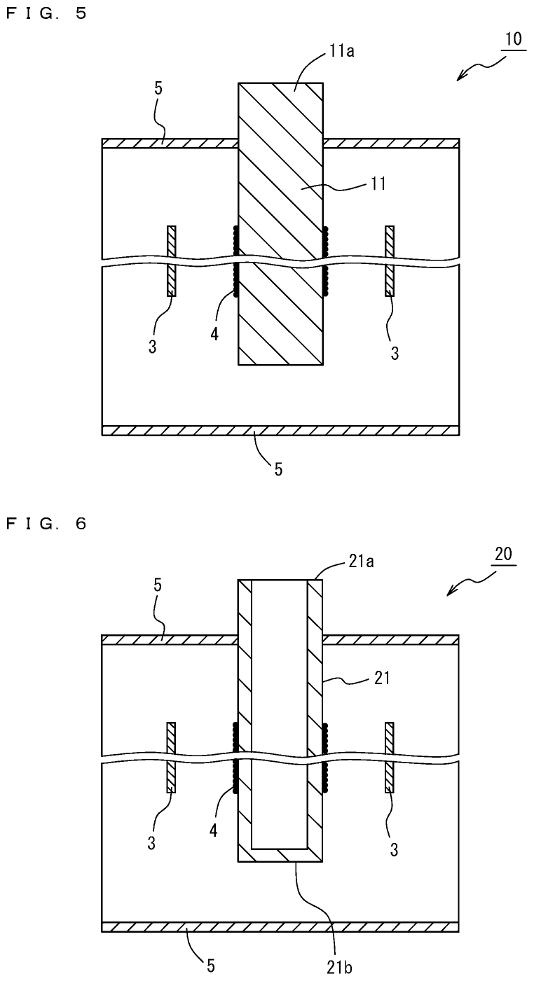

FIG. 3 is a schematic drawing of the phosphors 4 including phosphor particles 4a that have been applied to the surface of the support member 2 made of a metal. In the case of the phosphors 4 and the support member 2 of this drawing, any heat generated in the phosphors 4 hit by high-speed electrons “e” may be rapidly conducted from the phosphors 4 to the support member 2 because of its good thermal conductivity and direct contact with the phosphors 4. Thus, heat, if continues to be generated in the phosphors 4 hit by the electrons “e” one after another, may be efficiently conducted (transferred) to the support member 2 instead of being stored within in the phosphors 4. While the heat thus conducted from the phosphors 4 to the support member 2 may start to be stored in the support member 2, the stored heat may be released soon out of the device through ends of the support member 2. Thus, it may be very unlikely that the portion of the support member 2 in contact with the phosphors is heated to and reach temperatures at which the temperature quenching possibly occurs (approximately 70 to 100° C.).

The present invention thus uses the metallic support member 2 having a relatively large heat storage volume (large thermal capacity) and good thermal conductivity to allow the generated heat to be very efficiently released out of the device. Yet, some FELs of the known art may have 25 layers of the phosphor particles 4a, all of which receive impact from the electrons “e”. In such FELs, heat may be inevitably stored in such thick layers of the phosphors 4 unless the heat is quickly conducted to the support member 2, and a total heat storage volume per unit time in the whole phosphors 4 may exceed a largest heat release volume per unit time of the support member 2. Then, further heat storage in the support member 2, which is desirably avoided, may become inevitable. Besides, 24 layers of phosphors 4 having poor thermal conductivity may continue to be hit by one electrons one to another, for example, heat may be generated under impact from an electron even before heat generated earlier under such impact is ready to be conducted to the support member 2. If such impacts by electrons occur repeatedly, the phosphors 4 may reach higher temperatures than in any other parts of the device unless the phosphors 4 have sufficiently high thermal conductivity. Then, surface layers of the phosphor particles 4a facing the emitter may be subject to such high temperatures at which the temperature quenching possibly occurs, which may lead to breakage of the phosphors 4a. Hereinafter is described from a different angle why the conventional FELs can only last a month or so.

When the phosphors are hit by the electrons, heat generated then is conducted through the phosphors to the support member 2. In an example described below in which the yttrium oxide, Y₂0₃, is used as the phosphor material, the thermal conductivity of Y₂0₃ calculated by the following formula was 13.35 W/m·° C.

Y₂0₃; yttrium oxide, 3.19×10\hat{ }−2 (cal/cm/sec/° C.)

3.19×10\hat{ }−2=3.19×0.01=0.0319

0.0319 (cal/cm·sec·° C.)=0.0319 [(cm·sec·° C.)]×100 [cm/m]×1[° C./° K]×4.184 [J/cal]=(0.0319×4.184)×100≈13.35 W/m·° C.

Eu, europium; thermal conductivity of 13.9 W/m·° C.

The thermal conductivity of phosphors primarily consisting of an alloy Y₂0₃:Eu containing Y₂0₃ and Eu, though not as good as the thermal conductivities of metals, for example, Al; 250 W/m·° C., Zn; 116 W/m·° C., and Cu; 401 W/m·° C., may be considerably better than the thermal conductivities of mortar and stone, respectively, 1.73 W/m·° C. and 2 to 7 W/m·° C. In fact, the thermal conductivity of phosphors appears to be very passable in consideration of the thermal conductivity of stainless steel; 16 W/m·° C. The particle sizes of phosphors are 0.008 mm, which may lead to 25 layers when the phosphors are applied in the thickness of 0.2 mm. Since the phosphors are present in these 25 layers in the form of point contact, heat generated in response to impact when the emitter-side phosphors continue to be hit by the electrons may be conducted through point contacts between the phosphors and arrive at the glass of the light-irradiating surface.

The thermal conductivity of glass (flat glass, 0.96 W/m·° C., glass, 1.05 W/m·° C.) is, however, inferior to those of mortar and stone. While heat release through the glass thus having poor thermal conductivity is naturally taking more time, the electrons continue to arrive at the emitter-side phosphors, and heat is generated and stored within the phosphors. The thermal capacity of the phosphors may be too small when directly applied in the thickness of 0.2 mm to the glass having poor thermal conductivity.

Due to the mechanism described above, the FELs of the known art have proven to have short product lives of a month or so. On the other hand, the FEL according to the present invention, with an aim to extend the FEL product life to more than a month, addressed the issues of the known art by making the following improvements and successfully accomplished longer product lives.

Improvement [1]

Improvements of the support member 2 and the phosphors 4 were discussed and implemented. In the FEL of the known art, the phosphors 4 are applied to the glass of the light-irradiating surface. In the FEL 1 according to the present invention, on the other hand, the phosphors 4 are applied to the support member 2 (metal) that excels in thermal conductivity and electrical conductivity. Even though heat generated in the phosphors 4 may eventually arrive at the glass, the conduction of heat from the phosphors 4 to the glass can only slowly advance due to the poor thermal conductivity of glass, despite an effort to thicken the glass to increase its thermal capacity for better absorption of the heat from the phosphors 4. While heat transfer from the phosphors to the glass is very slow, the electrons continue to arrive at the phosphors, and heat thereby generated is stored within the phosphors 4 and invite temperature rises. This may be why and how the FEL conventionally fails to extend its product life.

First, improvements of the phosphors 4 are described.

In the FEL of the known art in which the phosphors 4 are applied in the thickness of 0.2 mm to the support member 2, approximately 25 phosphor particles 4a are estimated to be present on the surface of the support member 2 in layers.

In this regard, 25 layers are desirably decreased to as fewer layers as possible, most desirably to one layer. With one layer, for example, heat generated under impact from one electron to another may be conducted soon to the metal of the support member 2. The conventional FELs have the product life of approximately one month with 24 layers. With a fewer number of layers, 20, 10, 5, 3 and 1, heat generated by collision between the phosphors and the electrons may be smoothly conducted to and stored in the support member 2, instead of being stored in the phosphor layers.

Thus, heat generated by collision between the phosphors and electrons is stored in the support member 2. The heat storage volume at the time may increase with more collisions generating more heat, as the surface of the support member 2 is more exposed with a fewer number of layers, 20, 10, 5, 3 and 1. This may be rephrased that the phosphors 4 are preferably applied in fewer layers, i.e., thinner layers, and the surface of the support member 2 preferably has a smaller area of exposure, which may be recognized as an incontrovertible fact.

According to the present invention, the phosphors 4 may preferably be applied to the support member 2 in such a thickness that allows the support member 2 to be slightly glimpsed from between the phosphors 4 instead of entirely covering the emitter-side whole surface of the support member 2, i.e., to an extent that parts 2a are exposed on the surface of the support member 2 coated with the phosphors 4.

Since the present invention is directed to extending the product life, one month, of the conventional FELs to more than one month, the phosphor concentration used in the conventional FELs (1:1.8=phosphor:solution) should be used as a reference concentration in the present invention as well.

The phosphor-containing solutions having an equal concentration have an equal viscosity, and coating films thereby formed have an equal thickness. The phosphors of the conventional FELs use the product referred to as P22 (R, G, B), the composition of which is stated below.

Red—Y₂0₃:Eu, Green—ZnS:Cu,Au,Al, Blue—ZnS:Ag,Al

The R. B, B compounding ratio is 41:33:26 by percentage by weight.

The ratio of phosphors to the solution in the conventional FEL+ is 1:1.8 (wt). The phosphor-containing solution may further include the following.

Solvent: butyl acetate=1.686
Binder: nitrocellulose=0.014

### Adhesive: 0.1

The solvent+binder, 1.686+0.014, equals to 1.7.

The 10-fold solution of this composition is 1.7 g:0.1 g=17 g:x, and the binder of this 10-fold solution is X=1 g. Approximately 10 g of this solution may be sufficient when applied to test samples.

17 g:0.1 g=10 g:x g
x=0.059 g
1:1.8=x:10.059 g
x=5.59 g=phosphor quantity for 10 g of the solution,
The phosphors in the conventional FEL:solution=1:1.8,
phosphor:solution=1:1.8=5.59:10.059.

The phosphors are prepared in the form of dried powder. The viscosity of the solution, therefore, may be unaffected by the quantity of phosphors added to the solution. The standard number of layers is 25 at most when the thickness in one brush stroke is 0.2 m. The phosphor concentration with the standard 25 layers for 10 g of the solution is;

phosphor:solution=1:1.8
1:1.8=x:10
x=5.56
10 g of solution, phosphor 5.56 g=0.2 mm thickness, 25 layers
10 g of solution, phosphor 2.78 g, =0.2 mm thickness, 12.5 layers
10 g of solution, phosphor 1.39 g=0.2 mm thickness, 6.25 layers
10 g of solution, phosphor 0.7 g=0.2 mm thickness, 3.125 layers
10 g of solution, phosphor 0.34 g=0.2 mm thickness, 1.56 layers
10 g of solution, phosphor 0.17 g=0.2 mm thickness, 0.78 layer
10 g of solution, phosphor 0.087 g=0.2 mm thickness, 0.39 layer

The phosphor solutions for one or more layer layers are prepared, applied to the same metal pieces as the support member 2, and then observed with a microscope. An appropriate phosphor concentration may be decided in this manner.

### Point 1:

To achieve an improved thermal conductivity in the whole four phosphor layers to allow speedy thermal conduction to the support member 2 without the storage of heat generated under impact from electrons within the phosphors 4.

### Point 2:

To increase the volume (thermal capacity) of the support member 2 to largest volumes that can withstand different applications of use as light devices; for example, dimensions of the support member 2 may be 6 cm in diameter and 15 cm in length in household lighting devices, and 20 cm in diameter and 20 cm in length in work lighting devices.

### Point 3:

To address the issue of a short product life of about one month in the conventional FEL due to too thick phosphors 4 on thin glass having poor thermal conductivity.

The FELs of the known art had the product life of approximately one month due to its structural disadvantage; a thin glass member having poor thermal conductivity is coated with the phosphors in a large thickness.

Insofar as the points 1 and 2 are satisfied, heat of the phosphors 4 may be absorbed well correspondingly to the volume of the support member 2, which may successfully extend the product life of the phosphors 4. The point 3 is the issued to be addressed with the conventional FELs.

The product life, therefore, may be expected to substantially exceed one month without release of heat generated in the device into the atmosphere by having the support member 2 exposed in part out of the lighting device.

### Improvement [2]

The conventional FELs have the problem that the phosphors are directly applied to the glass of the light-irradiating surface. The thermal conductivity of glass is; flat glass 0.96 W/m·° C., glass 1.05 W/m·° C., which are inferior to those of mortar and stone; 1.73 W/m·° C. and 2 to 7 W/m·° C.

Using glass for heat release from the phosphors into the atmosphere may result in poor efficiency. To deal with this issue, the present invention provides the emitter 3 between the light-irradiating surface 5a and the phosphors 4 and applies the phosphors 4 to the surface of the metal that excels in both of electrical conductivity and thermal conductivity.

This may allow heat generated in the phosphors to be efficiently conducted to the metallic support member 2. To release heat stored within the support member 2 into the atmosphere, vent holes may be formed in a central part of the support member 2 in a manner that both ends of the holes penetrate through the glass and protrude into the atmosphere. The glass and the glass-penetrating part of support member are bonded and vacuum-sealed to each other.

The conventional FELs, in which the phosphors are directly applied to the glass of the light-irradiating surface having poor thermal conductivity, directly exchange heat with the atmosphere. These conventional FELs are, however, difficult to release heat stored in the thick phosphor layers into the atmosphere through the glass having poor thermal conductivity. While the phosphors inherently have poor thermal conductivity, the phosphors in the FELs, because they are powdered and present in layers in the form of point contact, have particularly poor thermal conductivity. Under the circumstances, the phosphors are hit by an electron to another discharged from the emitter and continue to generate heat. The conventional FELs could only have the product life of approximately one month because of heat-caused breakage of the phosphors.

In case the phosphors are applied to a metal having good thermal conductivity instead of the glass, heat generated by collision with the electrons from the emitter is conducted to the metal through an area of contact between the phosphors and the metal. The heat conducted from the phosphors is conducted to and diffuse soon into the whole metal because of its good thermal conductivity, which may prevent temperature rises in the area of contact between the phosphors and the metal. Because the volume of a metal corresponds to its thermal capacity, it requires more time with a metal having a greater volume to elevate the temperature in the area of contact between the phosphors and the metal.

In case the phosphors are applied to glass having poor thermal conductivity, heat continuously generated by collision with one electron to another from the emitter is conducted to the glass through an area of contact between the phosphors and the glass. While the glass has thermal conductivity substantially equal to those of mortar and stone and accordingly conducts heat rather slowly, the electrons from the emitter continue to hit the phosphors. This may lead to temperature rises in the area of contact between the phosphors and the glass. The conventional FELs could only have the product life of approximately one month because of this heat-caused breakage of the phosphors.

By greatly reducing the layers of phosphors in thickness, heat generated under impact from an electron to another from the emitter may be instantly transferred to a metal that excels in thermal conductivity. To this end, the phosphors may preferably be applied to the surface of the support member in a thickness small enough to an extent that the metallic support member is exposable in part through fine voids between the phosphors, i.e., in a thickness small enough to an extent that the support member can only be slightly glimpsed from between the phosphors. As the support member has a greater volume, i.e., a greater thermal capacity, longer periods of time may be required to elevate the temperature in the area of contact between the support member and the phosphors, which may promise a longer product life.

Thus, the product life may be extendible to more than one month without the stored heat being released into the atmosphere. Yet, insofar as the stored heat is releasable into the atmosphere, the lighting device may be continuously lighted on for long hours without periodically turning off to cool down the device.

To release the heat stored within the support member 2 into the atmosphere, vent holes may be formed in a central part of the support member 2 in a manner that both ends of these holes penetrate through the glass of the light-irradiating surface and protrude into the atmosphere. The glass and the glass-penetrating part of support member are bonded and vacuum-sealed to each other.

The description regarding the phosphors, “being present on the surface of the support member in a thickness small enough to an extent that the metallic support member is exposable in part through fine voids between the phosphors, i.e., in a thickness small enough to an extent that the support member can only be slightly glimpsed from between the phosphors”, is hereinafter described in further detail in connection with the following parts.

1) where the surface of the support member is exposed,
2) phosphor layer as thick as one to three phosphor particles,
3) phosphor layer as thick as four to seven phosphor particles, and
4) phosphor layer as thick as eight to 24 phosphor particles.

The part in 1) generates heat in response to the electrons discharged from the emitter crashing against the support member. In this part lacking any protection that blocks the electrons, the support member continues to be heated to higher temperature degrees and continues to receive heat from the phosphors. In case the quantity of heat release into the atmosphere is greater than the summed thermal capacity of the heat in 1) and the heat from the phosphors, the FEL may have a substantially infinite product life. The FEL, however, may have a shorter life in case the quantity of heat release into the atmosphere falls below the summed thermal capacity.

As for 2), heat generated by collision with the electrons from the emitter may be mostly conducted to the support member and may hardly be stored within the phosphor layers, the reasons of which are described in the paragraphs [0055] and [0056]. The product life may be shorter as the quantity of heat generated in 2) of the support member is greater than the quantity of heat released from the FEL into the atmosphere. On the other hand, the product life, though practically limited, might as well be substantially infinite as the quantity of heat generated in 1) of the support member is smaller than the quantity of heat released from the FEL into the atmosphere.

As for 3), the product life may be limited to a certain extent even if the quantity of heat generated in 1) of the support member is smaller than the quantity of heat released from the FEL into the atmosphere, causing sooner or later breakage of the phosphors, because heat continues to be stored within the phosphor layers, as a result of which the phosphors may be thereby finally broken and lost. Yet, a considerably long product life may be expected.

As for 4), the conventional FELs have a product life of approximately one month with approximately 24 phosphor layers. With eight to 24 phosphor layers, the product life may be at least more than a month.

Thus, the FEL includes the variously different parts described in 1) to 4).

It is important that, among 1) to 4), 1) is desirably less than the others.

Desirably, 2) and 3) are mostly present, with 4) less than 2) and 3), which represents the support member being “slightly glimpsed” or “exposed through fine voids”.

Some notes on how to apply the phosphors to the support member are hereinafter described in detail.

The phosphors may be applied to the support member in a manner that thick layers and thin layers are randomly present.

It may be not possible to spread the phosphors uniformly without any voids on the surface of the support member in one layer, two layers, or even in three to eight layers. It may be thus not possible to spread any powdery material uniformly without any voids on a target member in a specific range of thicknesses, i.e., in a specific number of layers. Any conceivable technique that makes it feasible could have been patented by now.

It is not possible to recite in claims any definite numeric values for the number of layers of phosphor particles. Thus, the thickness of applied phosphors is defined and restricted herein to an extent that “the support member is exposable in part through fine voids, i.e., the surface of the support member can only be slightly glimpsed from between the phosphors 4, instead of being entirely covered with the phosphors 4”.

With thick layers and thin layers of the phosphors being randomly mixed and distributed when the surface of the support member came to be glimpsed from between the phosphors (not the number of phosphor layers), the surface of the support member can be glimpsed from between the phosphors (a state of the phosphors being distributed). This may be rephrased that the surface of the support member may be exposed through fine voids between the phosphors at one or more positions.

The FEL thus structured is disposed so that the support member 2 is perpendicular to the ground surface. Thus, heat stored in the support member 2 may be released through the vent holes. The atmospheric air in the vent holes heated by the heat from the support member 2 is drifted upward and discharged through the vent holes. Then, cold air flows upward and into the vent holes, inducing the circulation of heat in the vent holes to release the heat from the support member 2 into the atmosphere.

To present the storage of heat in the support member of the FEL, the total quantity of the phosphors 4 in the FEL 1 according to this embodiment is defined such that the phosphors 4 include layers that are very thin as close as possible to a minimum quantity of the phosphors that can be obtained. Further, the thickness of the phosphors 4 is set to a very small value that the support member 2 is exposable in part through fine voids between the phosphors 4, instead of the whole emitter-side surface of the support member 2 being entirely covered with the phosphors 4, i.e., the support member 2 can be slightly glimpsed from between the phosphors 4 in a manner that parts 2a of the surface of the support member 2 are glimpsed from between the phosphors 4. By thus reducing the phosphor layers 4 in thickness to the minimum, the FEL according to the present invention may have a long product life in a part thereof where heat resulting from collision with the electrons “e” may be conducted speedily to the support member 2 instead of being stored within the phosphor layers. The FEL, however, may reach high temperatures and cease to emit light in another part thereof where the phosphors are very thick that heat is stored within the phosphor layers. The support member, which is partly glimpsed from between the phosphors 4, continues to generate heat whenever hit by the electrons and is finally no longer usable. Substantially the whole surface, except a part thereof, of the support member 2 is covered with the phosphors 4 to prevent as often as possible direct impact of the electrons “e” discharged from the emitter 3 against the support member 2.

The FEL 1 thus structured may successfully control the quantity of heat generated under impact from the electrons “e” and stored in the phosphors 4 and the total quantity of heat of the support member per se generated under direct impact from the electrons “e”. As a result, the total quantity of generated heat per unit time in the whole phosphors 4 may be very likely to fall below the quantity of heat per unit time released out of the device through the support member 2. The support member 2 may thereby effectively control the storage of heat therein. The support member 2 may also prevent being directly heated under direct impact from the electrons “e”, which may allow the storage of heat to be more certainly controlled. The FEL according to the present invention, therefore, has a great chance of life extension to more than one month.

In case the FEL 1 is turned on and operating for long hours, the phosphor particles 4a of the support member 2 may hardly reach temperatures at which the temperature quenching possibly occurs, or the phosphor particles 4a of the support member 2 may hardly reach temperatures at which the temperature quenching possibly occurs, or the phosphor particles 4a of the support member 2 may hardly stay at the temperatures for long periods of time. This may decrease the risk of the phosphors 4 (phosphor particles 4a) being degraded in quality.

To attain the effects described thus far, the FEL 1 further includes the transparent sealing glass 5 that covers the emitter 3, the support member 2 and the phosphors 4. Both ends of the support member 2 are penetrating through the transparent sealing glass 5 constituting the light-irradiating surface 5a and are protruding out of the FEL 1. Any gap between the support member 2 and the transparent sealing glass 5 is sealed to hermetically close the transparent sealing glass 5. This may allow the FEL 1 to release heat out of the device from the outer surface of the support member 2, more effectively reducing or eliminating the risk of the phosphors 4 being degraded in quality.

In the FEL 1, the metallic support member 2 and the transparent sealing glass 5 need to be tightly adhered to each other to close inside of the transparent sealing glass 5. Such tight adhesion and resulting tight closure are also needed to efficiently release heat stored in the support member 2 out of the FEL 1. Because of a large difference between the ratios of volume shrinkage of the metallic support member 2 and the transparent sealing glass 5, tight adhesion between the metallic support member 2 and the transparent sealing glass 5 with any gap being sealed may be difficult to perform without breaking the transparent sealing glass 5.

In this embodiment, the support member 2 and the transparent sealing glass 5 are adhered to each other to close inside of the transparent sealing glass 5 as described below. An adhesive is used in this embodiment, however, may be replaced with any other suitable means that allows materials of the support member 2 and of the transparent sealing glass 5 to adhere to each other. It may be recommended to use BOND ULTRA multi-purpose S-U (product name of multi-purpose elastic adhesive supplied by Konishi Co., Ltd.).

Prior to adhesion between the support member 2 and the transparent sealing glass 5, a sealing glass member 5 is separately prepared. This sealing glass member 5 has support member fitting holes 5e that have an equal shape to and a greater diameter than the vent holes formed in outer circumferential shape of the support member 2. The sealing glass member 5 further has joints 5f. As illustrated in FIG. 4, the sealing glass member 5 and the support member 2 are brought into proximity to each other, with the support member fitting holes 5e of the sealing glass member 5 being located to the outer circumferential surface of the support member 2. Then, an adhesive is poured into a gap between the support member 2 and the support member fitting holes 5e of the joints 5f to adhere these two members. At the time, both ends 2b (outer ends) of the support member 2 are left to stay out of the device.

Then, the support member 2 and the transparent sealing glass 5 having the joints 5f are adhered to each other to hermetically seal inside of the transparent sealing glass 5 including a central part of the support member 2.

As described thus far, the first embodiment pursues to ensure an adequate quantity of heat release of the support member 2 to make it difficult for the support member 2 to store the generated heat therein. However, the FEL according to the present invention is not necessarily so structured that both ends of the support member are penetrating through the transparent sealing glass and protruding out of the lighting device. The scope of the present invention includes an FEL 10 according to a second embodiment illustrated in FIG. 10. In this FEL 10, one end 11a alone of a support member 11 is penetrating through the transparent sealing glass 5 and protruding out of the lighting device 10. This may also ensure an adequate quantity of heat release of the support member 11 to make it difficult for the support member 11 to store the generated heat therein

FIG. 6 is a drawing of an FEL 20 according to a third embodiment which is a modified example of the FEL 10. The FEL 20 has a support member 21 having one end 21a alone protruding out of the device. The support member 21 has a hollowed portion from its one end 21a protruding out of the device to a longitudinally intermediate part 21b. The support member 21 on the whole has a cylindrical shape, and its intermediate part 21b alone has a closed end. Thus, the cylindrical inner space of the FEL 20 is sealed to allow inside of the device to be hermetically closed by the transparent sealing glass 5.

In the FEL 20, the support member 21 exposed out of the device has a cylindrical shape with a closed end, which increases the outer surface area of the support member 21 and accordingly increase its quantity of heat release. This structural feature may compensate for the quantity of heat release of the support member 21 with its one end 21a alone being exposed out of the device, making it difficult for the support member 21 to store the generated heat therein.

Instead of the intermediate part 21b having a closed end at one end 21a alone of the support member 21a, both ends 31a and 31b of a support member 31 in a cylindrical FEL 30 that both protrude out of this device may each have a closed end. This structural feature may further increase the outer surface area of the support member 31 exposed out of the FEL 30, inviting further increase of the quantity of heat release from the support member 31.

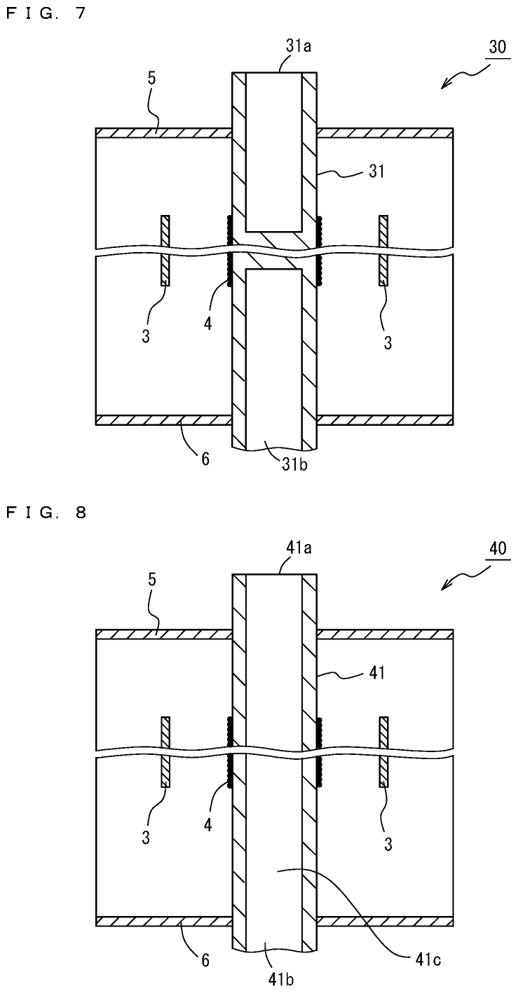

Other than the cylindrical support members with one or more closed ends illustrated in FIGS. 6 and 7, a fifth embodiment of the present invention provides an FEL 40 having a cylindrical support member 41 with opening ends 41a and 41b allowed to communicate with each other. This FEL 40 may allow inside of the device to be hermetically closed and also allow further increase of the outer surface area of the support member 41 exposed out of the FEL 40. Further advantageously, the convection of air (circulation of airflow) may occur between an inner space 41c of the support member 41 and a space on the outside of the device in contact with both ends 41a and 41b of the support member 41. This may allow the generated heat to be more efficiently released out of the device through the support member 41.

In the FEL 40 illustrated in FIG. 8, the bottom-less cylindrical support member 41 is vertically disposed relative to the transparent sealing glass 5. Warm air generated in the inner space of the support member 41 may be easily drifted upward and radiated outward from the upper end of the support member 41. As the warm air is radiated outward, another airflow (cold air) may be easily invited into the support member 41 from the lower end of the support member 41, which improves the efficiency of air convection between the inner space 41c of the support member 41 and outside of the device. As a result, the heat release may become even more efficient.

To attain the generally called chimney effect of warm air, the support member 41 may preferably be vertically disposed, however, may be disposed otherwise. It should be naturally understood that a sufficiently good effect of heat release is achievable regardless of whether the support member 41 is disposed otherwise, horizontally or diagonally.

The present invention is not necessarily limited to the embodiments described thus far and may be subject to various changes and/or various options, if necessary, within the scope of what is described herein.

### REFERENCE SIGNS LIST

1 FEL
2 support member
2a part of support member
2b both ends of support member
3 emitter
4 phosphor
4a phosphor particle
5 transparent sealing glass
5a surface to be irradiated with light (light-irradiating surface)
5e support member fitting hole
5f joint
6 power source
10 FEL
11 support member
11a one end of support member
20 FEL
21 support member
21b one end of support member
21b intermediate part of support member
30 FEL
31 support member
31a, 31b both ends of support member
40 FEL
41 support member
41a, 41b both ends of support member

1. A lighting device, comprising:
an emitter;
phosphors that receive electrons discharged from the emitter and that emit light toward to a surface to be irradiated with light; and
a support member that supports the phosphors, the support member including a material that excels in both of electrical conductivity and thermal conductivity,
the phosphors being present on a surface of the support member in a thickness small enough to an extent that the support member is exposable in part through fine voids between the phosphors.

2. The lighting device according to claim 1, wherein
the support member is exposed in part out of the lighting device, and
the phosphors are present on a surface of the support member in a thickness small enough to an extent that the support member is exposable in part through fine voids between the phosphors.

3. The lighting device according to claim 1, wherein
the phosphors are present in a quantity close to a minimum quantity of phosphors that can achieve an amount of fluorescence, which is a degree of luminance, required of the phosphors.

4. The lighting device according to one of claims 1 to 3, wherein
the material that excels in both of electrical conductivity and thermal conductivity is a metal.

5. The lighting device according to claim 1, wherein
the emitter is disposed between the phosphors and the surface to be irradiated with light.

6. The lighting device according to claim 1, further comprising a transparent sealing member that covers the emitter, the support member and the phosphors, wherein
at least one of ends on both sides of the support member is penetrating through the transparent sealing member and is protruding out of the lighting device,
a gap between the support member and the sealing member is sealed, and
inside of the transparent sealing member is hermetically closed.

7. The lighting device according to claim 1, wherein
ends on both sides of the support member are penetrating through the transparent sealing member and are protruding out of the lighting device.

8. The lighting device according to claim 7 wherein
the support member is disposed along a vertical direction.

9. The lighting device according to one of claims 6 to 8, wherein
the support member has a cylindrical shape with an opening at one of two ends on both sides thereof,
the opening at one end is protruding out of the lighting device, and
an inner space of the support member having a cylindrical shape is exposed out of the lighting device through the opening at one end.

10. The lighting device according to one of claims 6 to 8, wherein
the support member has a cylindrical shape with openings at two ends on both sides thereof,
the openings at two ends are protruding out of the lighting device, and
an inner space of the support member having a cylindrical shape is exposed out of the lighting device through the openings at two ends.
